(19) United States
(12) Patent Application Publication
(10) Pub. No.: US 2005/0260482 A1
(43) Pub. Date: Nov. 24, 2005

(54) Flow field plate arrangement

(76) Inventors: David Frank, Scarborough (CA); Nathaniel Ian Joos, Toronto (CA)

Correspondence Address: BERESKIN AND PARR, 40 KING STREET WEST, BOX 401, TORONTO, ON, M5H 3Y2, CA

(21) Appl. No.: 10/944,834

(22) Filed: Sep. 21, 2004

Related U.S. Application Data
(60) Provisional application No. 60/504,220, filed on Sep. 22, 2003.
(60) Provisional application No. 60/504,223, filed on Sep. 22, 2003.

(51) Int. Cl. H01M 8/02; H01M 8/04

(52) U.S. Cl. 429/38; 429/26

(57) ABSTRACT

Aspects of some embodiments of the present invention provide flow field plates that have been designed to include a flow field for uniformly distributing both a process gas/fluid and heat produced by an electrochemical reaction involving the process gas/fluid over an area covered by the flow field. Thus, for some embodiments of the present invention, in order to achieve a substantially uniform heat distribution and, possibly, in turn a substantially uniform reaction rate over the flow field, the process gas/fluid within each of the flow channels is preferably subjected to substantially the same heat exchange history as the process gas/fluid in any of the other flow channels. In some embodiments of the invention, this is accomplished by making all of the flow channels substantially the same total length.

### PRIORITY CLAIM

This application claims the benefit, under 35 USC 119(e), of U.S. Provisional Application Nos. 60/504,220 and 60/504,223 which were filed on Sep. 22, 2003; and, the entire contents of each of the U.S. Provisional Application Nos. 60/504,220 and 60/504,223 are hereby incorporated by reference. Moreover, this application is also a continuation-in-part of U.S. application Ser. No. ______ [Attorney Ref: 9351-444], entitled “Flow Field Plate Arrangement”, which was filed on Aug. 13, 2004, and the entire contents of which is also hereby incorporated by reference.

### FIELD OF THE INVENTION

The present invention relates to electrochemical cells, and, in particular to various arrangements of flow field plates suited for use therein.

### BACKGROUND OF THE INVENTION

An electrochemical cell, as defined herein, is an electrochemical reactor that may be configured as either a fuel cell or an electrolyzer cell. Generally, electrochemical cells of both varieties include an anode electrode, a cathode electrode and an electrolyte layer (e.g. a Proton Exchange Membrane) arranged between the anode and cathode electrodes. The anode and cathode electrodes are commonly provided in the form of flow field plates. Hereinafter it is to be understood that the designations “front surface” and “rear surface” indicate the orientation of a particular flow field plate with respect to an electrolyte layer. The “front surface” refers to a first surface facing an electrolyte layer, whereas, the “rear surface” refers to a second surface facing away from the electrolyte layer.

Process gases/fluids are supplied to and evacuated from the vicinity of the electrolyte layer through a flow field structure arranged on the front surface of a particular flow field plate. A flow field structure typically includes a number of open-faced channels referred to as flow field channels that are arranged to spread process gases/fluids over the electrolyte layer.

Various designs for flow field structures are known. A commonly known serpentine-shaped flow field structure is disclosed in U.S. Pat. Nos. 4,988,583, 6,099,984 and 6,309,773. Such a serpentine-shaped flow field structure provides a long flow channel within a compact area. However, it is difficult to control the flow, pressure and temperature of the process gases/fluids across a flow field plate that employs this structure. This structure also provides numerous places for water and contaminants to accumulate, increasing the risk of flooding or poisoning an electrochemical cell.

Moreover, as per convention, anode flow field channels usually have a different configuration as compared to cathode flow field channels due to the different stoichiometries of process gases/fluids associated with each flow field plate. The different stoichiometries often require different amounts of each process gas/fluid to be accommodated on each respective flow field plate, which in turn requires the flow field channels on each respective plate to support more or less volume than a corresponding flow field plate on the other side of the electrolyte layer.

Fuel cell reactions and electrolysis reactions are typically exothermic and temperature regulation is generally an important consideration in the design of an electrochemical cell stack, since the aforementioned reactions are temperature dependent. In particular, adequate temperature regulation provides a control point for the regulation of the desired electrochemical reactions; and, in some instances, helps to subdue undesired reactions that may occur. Heat can be carried away from electrochemical cells by process gases/fluids; yet, it is also often necessary to provide a separate coolant stream, that flows over the rear surfaces of the constituent flow field plates, to dissipate the heat generated during operation.

Conventional temperature regulation schemes only take the overall electrochemical cell stack temperature into consideration. The temperatures in specific areas within an electrochemical cell (e.g. across different areas of a flow field plate) cannot be regulated, since conventional heat dissipation techniques do not enable such careful temperature control.

### SUMMARY OF THE INVENTION

According to an aspect of an embodiment of the invention there is provided a flow field plate suited for use in an electrochemical cell including: a front surface and a rear surface; a plurality of manifold apertures; a flow field, on the front surface, fluidly connecting two of the manifold apertures, having a plurality of open-faced flow channels that are all substantially the same length and arranged to uniformly distribute both a first process gas/fluid and heat produced by an electrochemical reaction involving the first process gas/fluid over an area covered by the flow field on the front surface of the flow field plate.

In some embodiments, a flow field plate is circular in shape and has a central region and a peripheral region surrounding the central region on the front surface, wherein the flow field is arranged within the central region and the plurality of manifold apertures are symmetrically arranged in the peripheral region. In some related embodiments, each of the open-faced channels include, in sequence, a first straight portion in fluid communication with a first one of the manifold apertures, a tortuous portion, an arc portion, and a second straight portion in fluid communication with a second one of the manifold apertures.

In some embodiments a flow field plate is rectangular in shape and the open-faced channels are comprised of a plurality of substantially straight and parallel primary flow channels that extend along the length of the flow field plate. In some related embodiments, a flow field plate also includes: a plurality of inlet distribution flow channels that are fluidly connected between a first one of the manifold apertures and the primary flow channels, and wherein each of the inlet distribution flow channels has a longitudinally extending portion and a transversely extending portion; and, a plurality of outlet collection flow channels that are fluidly connected between a second one of the manifold apertures and the primary flow channels, and wherein each of the outlet collection flow channels has a longitudinally extending portion and a transversely extending portion.

In some embodiments, a flow field plate also includes a coolant flow field, on the rear surface, fluidly connecting two of the manifold apertures, having a plurality of open-faced flow channels that are all substantially the same length and arranged to uniformly distribute coolant on the rear surface of the flow field plate.

In some embodiments, a flow field plate also includes: a first slot, extending through the flow field plate, that is in fluid communication with the open-faced channels of the flow field on the front surface and in fluid communication with a first one of the manifold apertures on the rear surface; and, a second slot, extending through the flow field plate, that is in fluid communication with the open-faced channels of the flow field on the front surface and in fluid communication with a second one of the manifold apertures on the rear surface. In some related embodiments, a flow field plate also includes: a first set of aperture extensions extending from the first one of the manifold apertures to the first slot, over a portion of the rear surface; and a second set of aperture extensions extending from the second one of the manifold apertures to the second slot, over a portion of the rear surface.

In some embodiments, some of the manifold apertures are used to supply or evacuate process gases/fluids and each of these manifold apertures has substantially the same area as the other manifold apertures also used to supply or evacuate process gases/fluids. In some related embodiments, all of the manifold apertures used to supply or evacuate respective process gases/fluids also have substantially identical dimensions.

According to aspects of anther embodiment of the invention there is provided a flow field plate suited for use in an electrochemical cell including a flow field having a plurality of open-faced flow channels that are all substantially the same length and arranged to uniformly distribute both a first process gas/fluid and heat produced by an electrochemical reaction involving the first process gas/fluid over an area covered by the flow field.

In some embodiments, a flow field plate also includes: a plurality of substantially identical manifold apertures that are arranged to align with respective manifold apertures on other similar flow field plates to form a corresponding plurality of elongate channels that each extend through the thickness of a combined number of similar flow field plates.

According aspects of yet another embodiment of the invention there is provided an electrochemical cell stack including at least one electrochemical cell, each electrochemical cell including: a plurality of flow field plates each including a flow field wherein, each flow field includes a plurality of open-faced flow channels that are all substantially the same length and arranged to uniformly distribute both a first process gas/fluid and heat produced by an electrochemical reaction involving the first process gas/fluid over an area covered by the flow field; and, wherein some of the flow field plates are employed as an anode and some of the flow field plates are employed as a cathode.

In some embodiments, all of the plurality of flow field plates have substantially identical manifold apertures and wherein the respective manifold apertures on the flow field plates align to form a corresponding plurality of elongate channels that each extend through the electrochemical cell stack.

Other aspects and features of the present invention will become apparent, to those ordinarily skilled in the art, upon review of the following description of the specific embodiments of the invention.

### BRIEF DESCRIPTION OF THE DRAWINGS

For a better understanding of the present invention, and to show more clearly how it may be carried into effect, reference will now be made, by way of example, to the accompanying drawings that illustrate aspects of embodiments of the present invention and in which:

FIG. 1 is a simplified schematic drawing of an electrolyzer cell module;

FIG. 2 is an exploded perspective view of an electrolyzer cell module;

FIG. 3A is a schematic drawing of a front surface of an anode flow field plate according to aspects of an embodiment of the invention;

FIG. 3B is a schematic drawing of a rear surface of the anode flow field plate illustrated in FIG. 3A;

FIG. 3C is an enlarged partial view of a water manifold aperture and adjacent parts on the front surface of the anode flow field plate illustrated in FIG. 3A;

FIG. 3D is an enlarged partial sectional view of the anode flow field plate taken along line A-A in FIG. 3C;

FIG. 3E is an enlarged partial sectional view of the anode flow field plate taken along line B-B in FIG. 3C;

FIG. 3F is an enlarged partial view of a coolant manifold aperture and adjacent parts on the rear surface of the anode flow field plate illustrated in FIG. 3B;

FIG. 3G is an enlarged partial sectional view of the anode flow field plate taken along line C-C in FIG. 3F;

FIG. 3H is an enlarged partial perspective view of another water manifold aperture and adjacent parts on the rear surface of the anode flow field plate illustrated in FIG. 3B;

FIG. 4 is a schematic drawing of a front surface of a corresponding cathode flow field plate suited for use with the anode flow field plate illustrated in FIG. 3A, according to aspects of an embodiment of the invention; and

FIG. 5 is a schematic drawing of a rectangular flow field plate according to aspects of an embodiment of the invention suited for use in the electrolyzer cell module illustrated in FIG. 2.

### DETAILED DESCRIPTION OF THE INVENTION

According to aspects of embodiments of the present invention, provided are arrangements for flow field structures that affect heat distribution across the surface of a flow field plate. Specifically, as described below, some embodiments provide a flow field structure that distributes heat more uniformly across an active surface of a flow field plate, which in turn may lead to a more uniform reaction rate over the active area of a flow field plate. Other related embodiments, described below, also include simplifications that may reduce costs related to manufacturing and assembly of electrochemical cells.

It was noted above that conventional electrochemical cell stacks include anode flow field plates that have a flow field structure that is different than that included on corresponding cathode flow field plates. A consequence of this is that the ribs that define the flow field structure on an anode flow field plate are often offset with those on a corresponding cathode flow field plate. Shearing forces resulting from the offset may damage an electrolyte membrane arranged between the flow field plates. The offset between the flow field plates may, in some specific instances, also impede the distribution of process gases/fluids within an electrochemical cell, thereby reducing efficiency. Another consequence is that the differences make the manufacturing and assembly of flow field plates complicated and costly.

Aspects of the flow field structures and plate arrangements according to examples described in the applicant's co-pending U.S. patent application Ser. No. 10/109,002 (filed 29-Mar.-2002) can be employed to provide reduced shearing forces on a membrane and simplify sealing between flow field plates. The entire contents of the applicant's co-pending U.S. patent application Ser. No. 10/109,002 are hereby incorporated by reference.

As disclosed in the applicant's co-pending U.S. patent application Ser. No. 10/109,002, after assembly, a substantial portion of the anode flow field channels and the cathode flow field channels are disposed directly opposite one another with an electrolyte membrane arranged between the two plates. Accordingly, a substantial portion of the ribs on the anode flow field plate match-up with a corresponding substantial portion of the ribs on the cathode flow field plate. This is described as “rib-to-rib” pattern matching hereinafter.

Aspects of flow field plate arrangements according to examples described in the applicant's co-pending U.S. patent application Ser. No. 09/855,018 (filed 15-May-2001) can also be employed to provide an effective sealing between flow field plates and an electrolyte membrane arranged between the two plates. The entire contents of the applicant's co-pending U.S. patent application Ser. No. 09/855,018 are hereby incorporated by reference.

As disclosed in the applicant's co-pending U.S. patent application Ser. No. 09/855,018, the inlet flow of a particular process gas/fluid from a respective manifold aperture does not take place directly over the front (active) surface of a flow field plate; rather, the process gas/fluid is first guided from the respective manifold aperture over a portion of the rear (passive) surface of the flow field plate and then through a “back-side feed” aperture extending from the rear surface to the front surface. A portion of the front surface defines an active area that is sealingly separated from the respective manifold aperture over the front surface when an electrochemical cell stack is assembled. The portion of the rear surface over which the inlet flow of the process gas/fluid takes place has open-faced gas/fluid flow field channels in fluid communication with the respective manifold aperture. The back-side feed apertures extend from the rear surface to the front surface to provide fluid communication between the active area and the open-faced gas/fluid flow field channels that are in fluid communication with the respective manifold aperture. Accordingly, as described in the examples provided in the applicant's co-pending U.S. patent application Ser. No. 09/855,018, a seal between the membrane and the flow field plate can be made in an unbroken path around the periphery of the membrane.

In prior art examples, the seal between the membrane and the active area on the front surface of the flow field plate, which is typically around the periphery of the membrane, is broken by the open-faced flow field channels leading up to respective manifold apertures from the active area on the front surface of the flow field plate. By contrast, according to the applicant's aforementioned co-pending application a process gas/fluid is fed to the active area on the front surface through back-side feed apertures from the rear surface of each flow field plate, and a sealing surface separates the back-side feed apertures and the respective manifold aperture(s) on the front surface of each flow field plate. This method of flowing fluids from a rear (passive or non-active) surface to the front (active) surface is referred to as “back-side feed” in the description. Those skilled in the art will appreciate that gases/fluids can be evacuated from the active area on the front surface to the rear surface and then into another manifold aperture in a similar manner.

Aspects of flow field plate arrangements according to examples described in the applicant's co-pending U.S. patent application Ser. No. 10/845,263 (filed 14-May-2004) can also be employed to provide an effective sealing between flow field plates and a membrane arranged between the two electrodes. The entire contents of the applicant's co-pending U.S. patent application Ser. No. 10/845,263 are hereby incorporated by reference.

As disclosed in the applicant's co-pending U.S. patent application Ser. No. 10/845,263, the inlet flow of a particular process gas/fluid from a respective manifold aperture does not take place directly over the front (active) surface of a flow field plate; rather, the process gas/fluid is first guided from the respective manifold aperture over a portion of an oppositely facing complementary active surface, included in an adjacent electrochemical cell, and then through a “complementary active-side feed” aperture extending through to the front surface of the flow field plate. According to examples described in the applicant's co-pending U.S. patent application Ser. No. 10/845,263 a seal between the membrane and the flow field plate can be made in an unbroken path around the periphery of the membrane, without requiring the flow field plate to have a passive surface, as in the examples described in the applicant's co-pending U.S. patent application Ser. No. 09/855,018.

Aspects of flow field plate arrangements according to examples described in the applicant's co-pending U.S. patent application Ser. No. 10/845,263 also provide for a symmetrical flow field plate arrangement that enables the use of a single flow field plate design for both anode and cathode flow field plates employed in an electrochemical cell stack. That is, in some embodiments, the anode and cathode flow field plates employed for use in an electrochemical cell stack are substantially identical.

It was also noted above that the various process gases/fluids, employed and produced within a particular electrochemical cell, typically have different stoichiometries relative to one another. Thus, as per convention, in order to optimize the performance of an electrochemical cell each respective manifold aperture provided on a flow field plate for a corresponding process gas/fluid is sized so that each process gas/fluid is supplied and/or evacuated in a manner relative to a corresponding stoichiometry.

For example, with respect to hydrogen-powered fuel cells, two hydrogen molecules are consumed for each oxygen molecule consumed. This requires more hydrogen to flow over a respective anode flow field plate than a corresponding stoichiometric amount of oxygen flowing over a corresponding cathode flow field plate. This is achieved by making the input and output manifold apertures for the hydrogen larger than those for the oxidant.

However, if air is used as the source of oxygen the aforementioned relative sizing is reversed. Air is only about 20% oxygen and so more air is needed to provide the required stiochiometric amount of oxygen than if pure oxygen is supplied. Accordingly, inlet and outlet manifold apertures for the oxidant are made larger than those for the hydrogen fuel.

In another example, with respect to water supplied electrolyzers, two hydrogen molecules (H₂) are produced for each oxygen (O₂) molecule produced. This results in more hydrogen flowing over a respective cathode flow field plate than a corresponding stoichiometric amount of oxygen flowing over a corresponding anode flow field plate. Typically, flow field plates adapted for use in electrolyzers have input and output manifold apertures for the hydrogen that are larger than those for the oxidant; and additionally, the widths of the flow field channels on the cathode flow field plate are made wider than the widths of the flow field channels on the anode flow field plate to accommodate the relatively larger volume of hydrogen on the cathode side of the electrolyte layer.

Aspects of flow field plate arrangements according to examples described in the applicant's co-pending U.S. patent application Ser. No. ______ [Attorney Ref: 9351-444] (filed 13-Aug.-2004) provide a number of manifold apertures, each for one of various process gases/fluids, that are the same size as one another. In other words, for example, the inlet manifold apertures provided for hydrogen and oxygen on a flow field plate have substantially the same area and in some specific embodiments they also have substantially identical dimensions. The entire contents of the applicant's co-pending U.S. patent application Ser. No. ______ [Attorney Ref: 9351-444] are hereby incorporated by reference. It is also noted that the applicant's co-pending U.S. patent application Ser. No. ______ [Attorney Ref: 9351-444] is based on the applicant's Provisional Application 60/495,092 (filed 15-Aug.-2003) that the present application has claimed the benefit of above.

It is commonly understood that in practice a number of electrochemical cells, all of one type, can be arranged in stacks having common features, such as process gas/fluid feeds, drainage, electrical connections and regulation devices. That is, an electrochemical cell module is typically made up of a number of singular electrochemical cells connected in series to form an electrochemical cell stack. The electrochemical cell module also includes a suitable combination of associated structural elements, mechanical systems, hardware, firmware and software that is employed to support the function and operation of the electrochemical cell module. Such items include, without limitation, piping, sensors, regulators, current collectors, seals, insulators and electromechanical controllers.

As noted above, flow field plates typically include a number of manifold apertures that each serve as a portion of a corresponding elongate distribution channel for a particular process gas/fluid. In some embodiments, the cathode of an electrolyzer cell does not need to be supplied with an input process gas/fluid and only hydrogen gas and water need to be evacuated. In such electrolyzer cells a flow field plate does not require an input manifold aperture for the cathode but does require an output manifold aperture. By contrast, a typical embodiment of a fuel cell makes use of inlet and outlet manifold apertures for both the anode and the cathode. However, a fuel cell can also be operated in a dead-end mode in which process reactants are supplied to the fuel cell but not circulated away from the fuel cell. In such embodiments, only inlet manifold apertures are provided.

There are a number of different electrochemical cell technologies and, in general, this invention is expected to be applicable to all types of electrochemical cells. Very specific example embodiments of the invention have been developed for use with Proton Exchange Membrane (PEM) electrolyzer cells. Various types of electrolyzer cells include, without limitation, Solid Polymer Water Electrolyzers (SPWE). Similarly, various types of fuel cells include, without limitation, Alkaline Fuel Cells (AFC), Direct Methanol Fuel Cells (DMFC), Molten Carbonate Fuel Cells (MCFC), Phosphoric Acid Fuel Cells (PAFC), Solid Oxide Fuel Cells (SOFC) and Regenerative Fuel Cells (RFC).

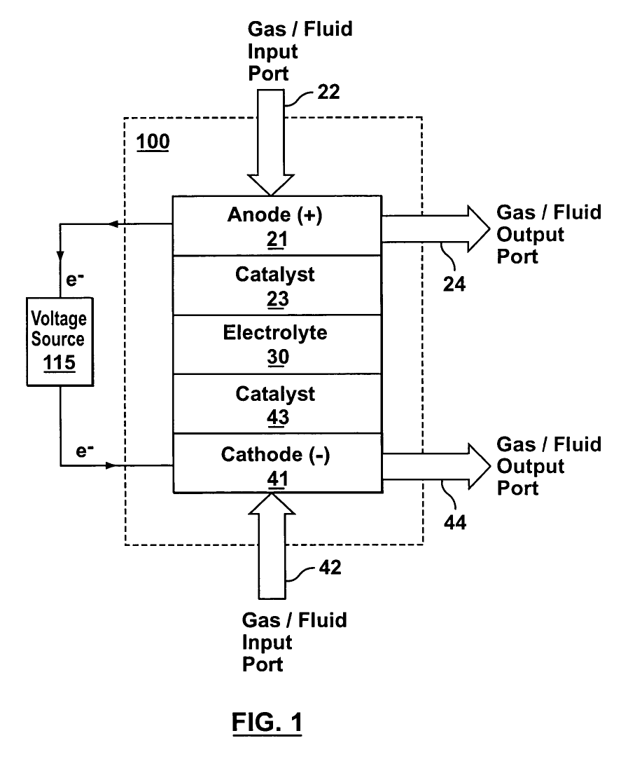

Referring to FIG. 1, shown is a simplified schematic diagram of a Proton Exchange Membrane (PEM) electrolyzer cell module, simply referred to as electrolyzer cell module 100 hereinafter, that is described herein to illustrate some general considerations relating to the operation of electrochemical cell modules. It is to be understood that the present invention is applicable to various configurations of electrochemical cell modules that each include one or more electrochemical cells. Those skilled in the art would appreciate that a PEM fuel cell module has a similar configuration to the PEM electrolyzer cell module 100 shown in FIG. 1.

The electrolyzer cell module 100 includes an anode electrode 21 and a cathode electrode 41. The anode electrode 21 includes a water input port 22 and a water/oxygen output port 24. Similarly, the cathode electrode 41 includes a water input port 42 and a water/hydrogen output port 44. An electrolyte membrane 30 is arranged between the anode electrode 21 and the cathode electrode 41.

The electrolyzer cell module 100 also includes a first catalyst layer 23 between the anode electrode 21 and the electrolyte membrane 30, and a second catalyst layer 43 between the cathode electrode 41 and the electrolyte membrane 30. In some embodiments the first and second catalyst layers 23, 43 are deposited on the anode and cathode electrodes 21, 41, respectively.

A voltage source 115 is coupled between the anode electrode 21 and the cathode electrode 41.

In operation, water is introduced into the anode electrode 21 via the water input port 22. The water is dissociated electrochemically according to reaction (1), given below, in the presence of the electrolyte membrane 30 and the first catalyst layer 23.
H₂O→2H⁺+2e⁻+½O₂ (1)
The chemical products of reaction (1) are hydrogen ions (i.e. cations), electrons and oxygen. The hydrogen ions pass through the electrolyte membrane 30 to the cathode electrode 41 while the electrons are drawn through the voltage source 115. Water containing dissolved oxygen molecules is drawn out through the water/oxygen output port 24.

Simultaneously, additional water is introduced into the cathode electrode 41 via the water input port 42 in order to provide moisture to the cathode side of the membrane 30.

The hydrogen ions (i.e. protons) are electrochemically reduced to hydrogen molecules according to reaction (2), given below, in the presence of the electrolyte membrane 30 and the second catalyst layer 43. That is, the electrons and the ionized hydrogen atoms, produced by reaction (1) in the anode electrode 21, are electrochemically consumed in reaction (2) in the cathode electrode 41.
2H₂⁺+2e⁻→H₂ (2)

The water containing dissolved hydrogen molecules is drawn out through the water/hydrogen output port 44. The electrochemical reactions (1) and (2) are complementary to one another and show that for each oxygen molecule (O₂) that is electrochemically produced two hydrogen molecules (H₂) are electrochemically produced.

In a similarly configured PEM fuel cell the reactions (2) and (1) are respectively reversed in the anode and cathode. This is accomplished by replacing the voltage source 115 with a load and supplying hydrogen to the anode electrode 21 and oxygen to the cathode electrode 41. The load is coupled to employ a generated electric potential that is of the opposite polarity to that shown on the anode and cathode electrodes 21 and 41, respectively, of FIG. 1. The products of such a PEM fuel cell include water, heat and an electric potential.

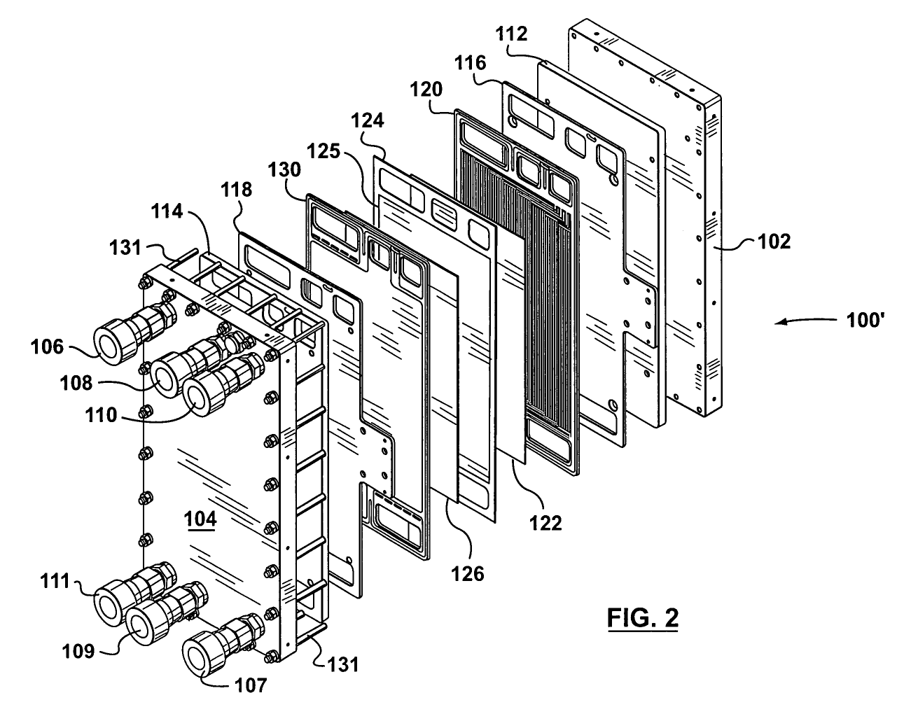

Referring now to FIG. 2, illustrated is an exploded perspective view of an electrolyzer cell module 100′. For the sake of brevity and simplicity, only the elements of one electrochemical cell are shown in FIG. 2. That is, the electrolyzer cell module 100′ includes only one electrolyzer cell; however, an electrolyzer cell stack will usually include a number of electrolyzer cells stacked together. The electrolyzer cell of the electrolyzer cell module 100′ comprises an anode flow field plate 120, a cathode flow field plate 130, and a Membrane Electrode Assembly (MEA) 124 arranged between the anode and cathode flow field plates 120, 130. Again, the designations “front surface” and “rear surface” with respect to the anode and cathode flow field plates 120, 130 indicate their respective orientations with respect to the MEA 124. The “front surface” of a flow field plate is the side facing towards the MEA 124, while the “rear surface” faces away from the MEA 124.

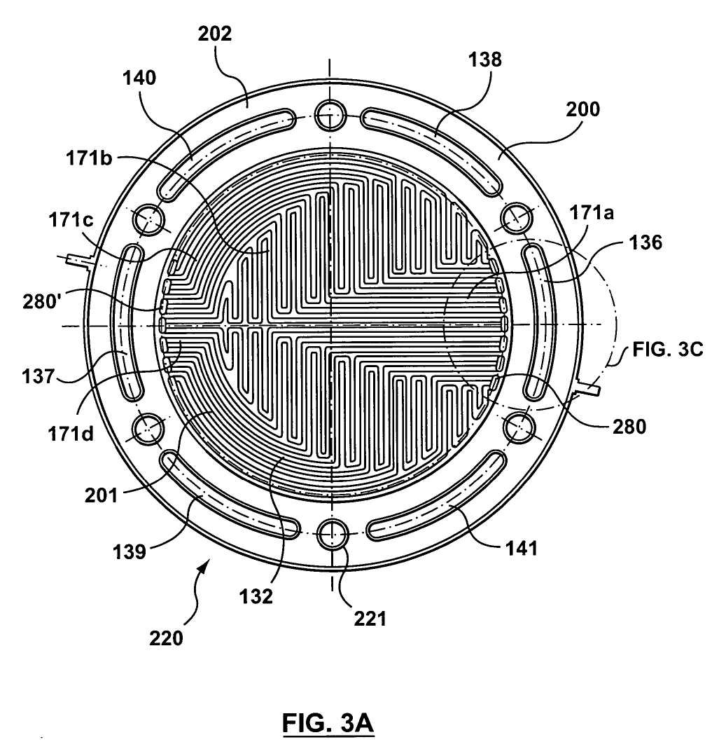

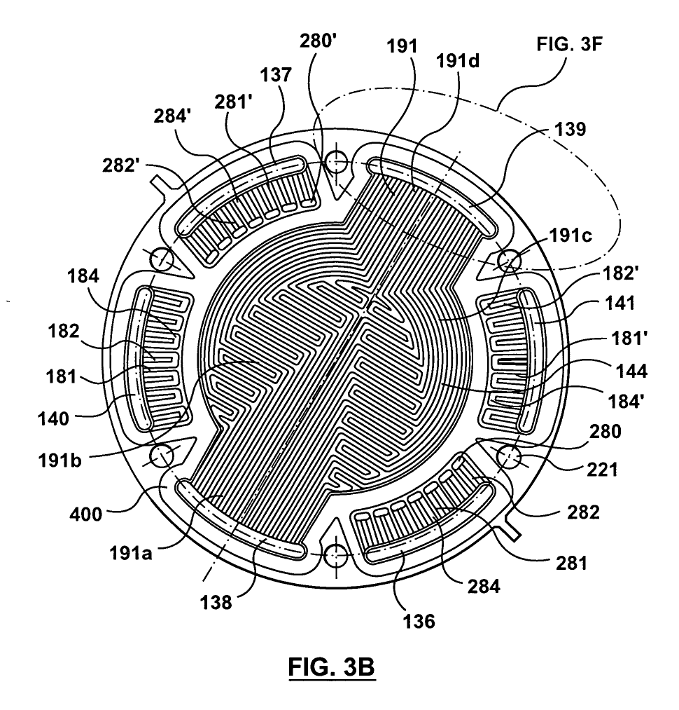

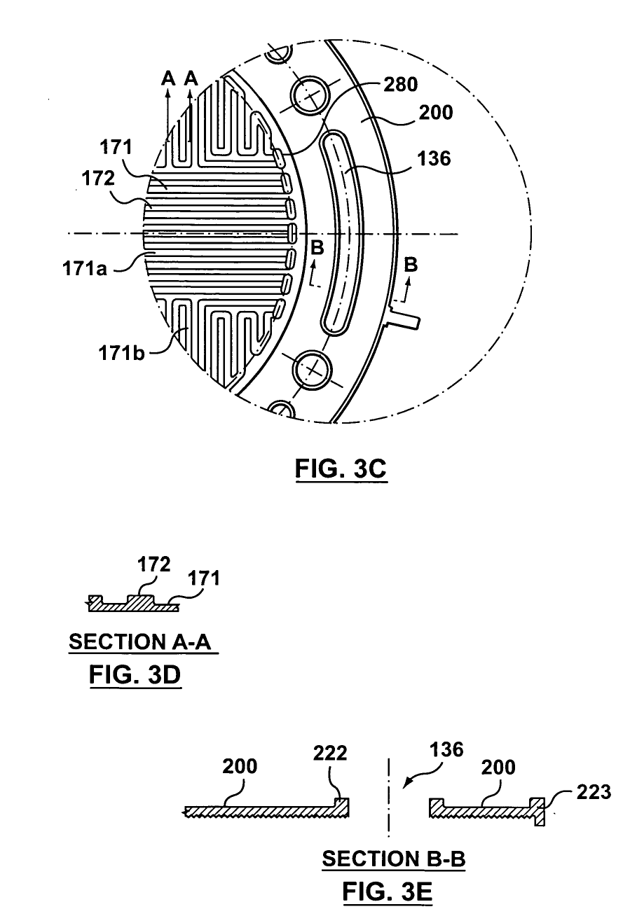

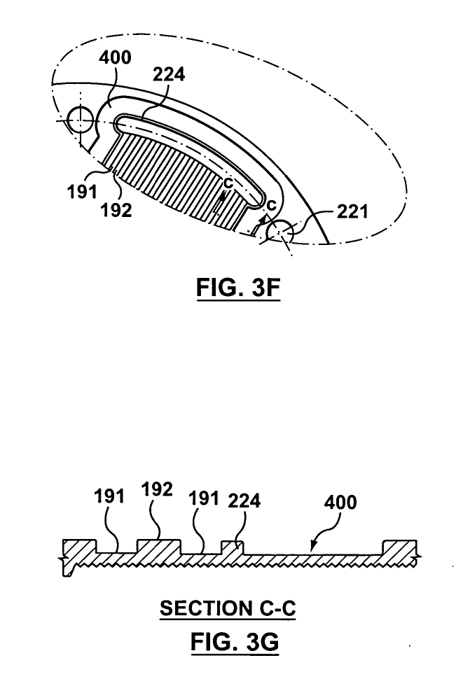

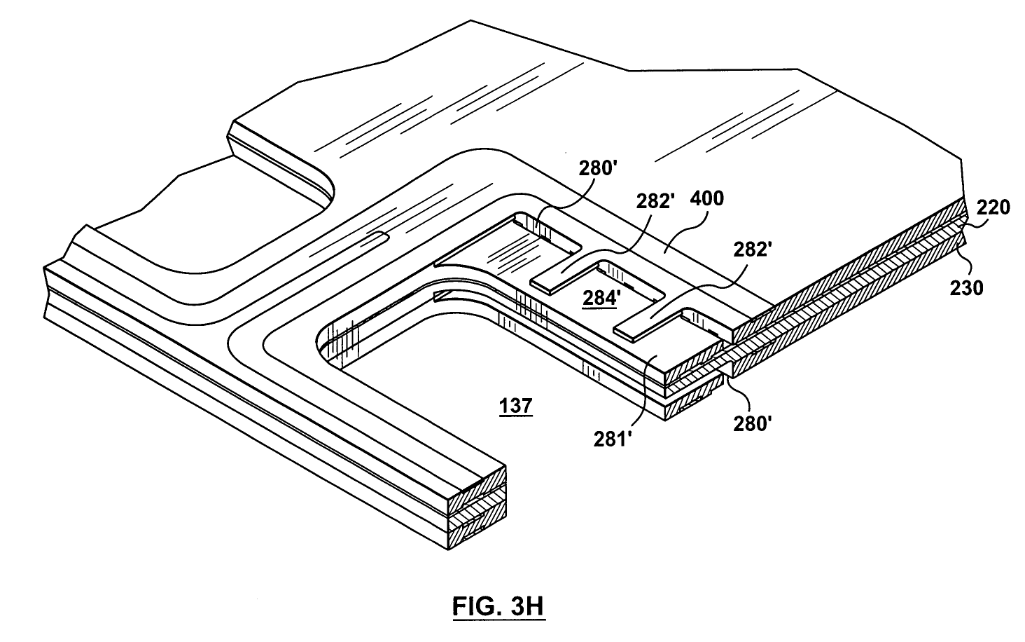

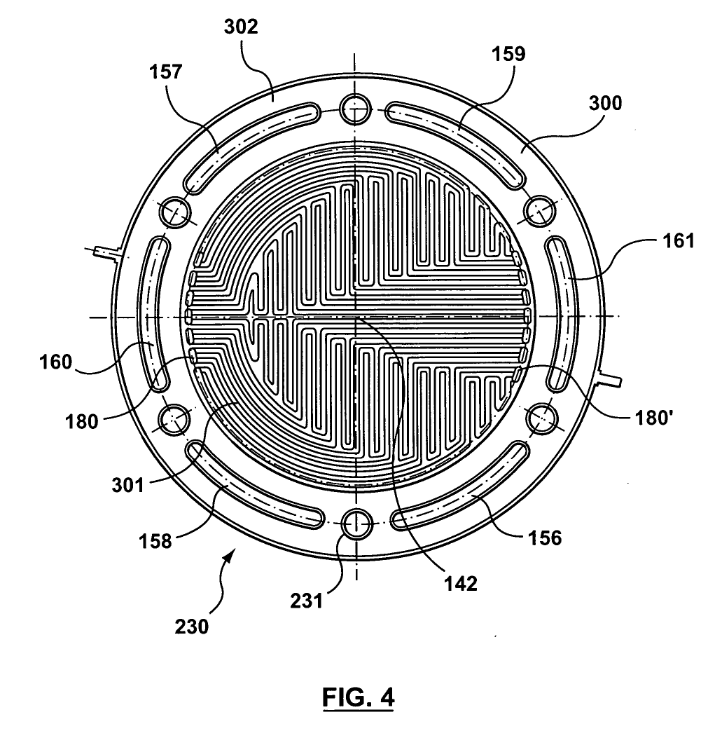

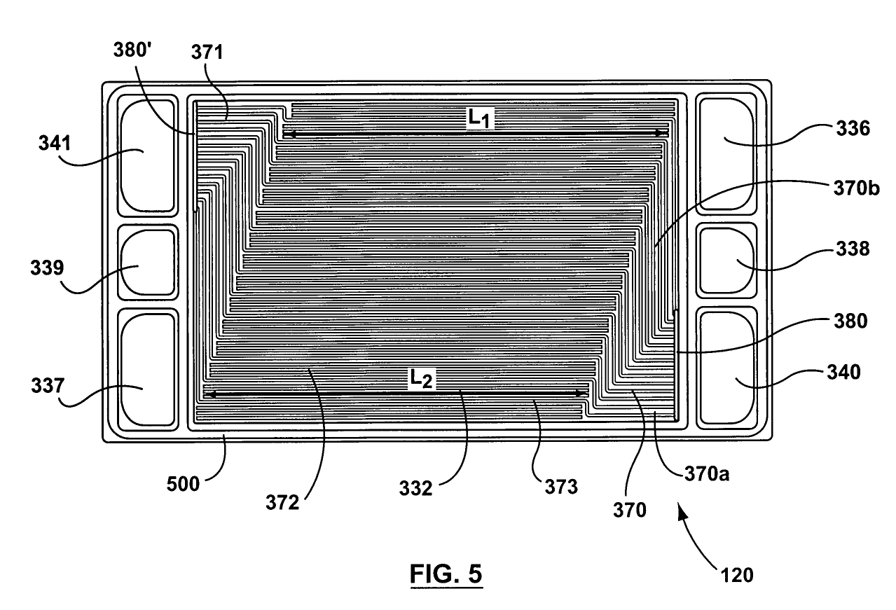

Briefly, each flow field plate 120, 130 has an inlet region and an outlet region. In this particular embodiment, for the sake of clarity, the inlet and outlet regions are placed on opposite ends of each flow field plate, respectively. However, various other arrangements are also possible. Each flow field plate 120, 130 also includes a number of open-faced flow channels that fluidly connect the inlet to the outlet regions and provide a structure for distributing the process gases/fluids to the MEA 124. Examples of anode flow field plates according to aspects of embodiments of the invention will be described below with reference to FIGS. 3A-3H and FIG. 5. An example of a cathode flow field plate according to the aspects of an embodiment of the invention will be described in detail below with reference to FIG. 4.

The MEA 124 includes a solid electrolyte (e.g. a proton exchange membrane) 125 arranged between an anode catalyst layer (not shown) and a cathode catalyst layer (not shown).

The electrolyzer cell of the electrolyzer cell module 100′ also includes a first Gas Diffusion Media (GDM) 122 that is arranged between the anode catalyst layer and the anode flow field plate 120, and a second GDM 126 that is arranged between the cathode catalyst layer and the cathode flow field plate 130. The GDMs 122, 126 facilitate the diffusion of the process gases/fluids to the catalyst surfaces of the MEA 124. The GDMs 122, 126 also enhance the electrical conductivity between each of the anode and cathode flow field plates 120, 130 and the solid electrolyte 125 (e.g. a proton exchange membrane).

The elements of the electrolyzer cell are enclosed by supporting elements of the electrolyzer cell module 100′. Specifically, the supporting elements of the electrolyzer cell module 100′ include an anode endplate 102 and a cathode endplate 104, between which the electrolyzer cell and other elements are appropriately arranged. In the present embodiment, the cathode endplate 104 is provided with connection ports for supply and evacuation of process gases/fluids. The connection ports will be described in greater detail below.

Other elements arranged between the anode and cathode endplates 102, 104 include an anode insulator plate 112, an anode current collector plate 116, a cathode current collector plate 118 and a cathode insulator plate 114, respectively. In different embodiments varying numbers of electrochemical cells are arranged between the current collector plates 116, 118. In such embodiments the elements that make up each electrochemical cell are appropriately repeated in sequence to provide an electrochemical cell stack that produces the desired output. In many embodiments a sealing means is provided between plates as required to ensure that the various process gases/fluids are isolated from one another.

In order to hold the electrolyzer cell module 100′ together, tie rods 131 are provided that are screwed into threaded bores in the anode endplate 102 (or otherwise fastened), passing through corresponding plain bores in the cathode endplate 104. Nuts and washers or other fastening means are provided, for tightening the whole assembly and to ensure that the various elements of the individual electrochemical cells are held together.

As noted above various connection ports to an electrochemical cell stack are included to provide a means for supplying and evacuating process gases, fluids, coolants etc. In some embodiments, the various connection ports to an electrochemical cell stack are provided in pairs. One of each pair of connection ports is arranged on a cathode endplate (e.g. cathode endplate 104) and the other is appropriately placed on an anode endplate (e.g. anode endplate 102). In other embodiments, the various connection ports are only placed on either the anode or cathode endplate. It will be appreciated by those skilled in the art that various arrangements for the connection ports may be provided in different embodiments of the invention.

With continued reference to FIG. 2, the cathode endplate 104 has first and second water/oxygen connection ports 106, 107, first and second coolant connection ports 108, 109, and first and second water/hydrogen connection ports 110, 111. The ports 106-111 are arranged so that they will be in fluid communication with manifold apertures included on the MEA 124, the first and second gas diffusion media 122, 126, the anode and cathode flow field plates 120, 130, the first and second current collector plates 116, 118, and the first and second insulator plates 112, 114. The manifold apertures on all of the aforementioned plates align to form three sets of elongate inlet and outlet channels.

The electrolyzer cell module 100′ is operable to facilitate a catalyzed reaction. As described above, water is dissociated at the anode catalyst layer of the MEA 124 to form protons, electrons and oxygen molecules. The solid electrolyte (e.g. proton exchange membrane) 125 facilitates migration of the protons from the anode catalyst layer to the cathode catalyst layer. Most of the free electrons will not pass through the solid electrolyte 125, and instead flow through a voltage source (e.g. voltage source 115 in FIG. 1) via the current collector plates 116, 118, as a result of an electromotive force provided by the voltage source. With the cathode catalyst layer of the MEA 124, protons and electrons are reduced to hydrogen molecules, according to reaction (2). The oxygen and hydrogen produced at the anode and cathode respectively are dissolved in water supplied to the electrodes. The oxygen and hydrogen remain dissolved as long as the respective water/gas streams remain pressurized.

Simultaneously, a coolant flow through the electrolyzer cell module 100′ is provided to the electrolyzer cell(s) via connection ports 108, 109 and coolant manifold apertures in the aforementioned plates. As the electrolyzer cell reaction is exothermic and the reaction rate is sensitive to temperature, the flow through of coolant takes away the heat generated in the electrolyzer cell reactions, preventing the temperature of the fuel cell stack from increasing, thereby regulating the electrolyzer cell reactions to a stable level. The coolant is a gas or fluid that is capable of providing a sufficient heat exchange that will permit cooling of the stack. Examples of known coolants include, without limitation, water, deionized water, oil, ethylene glycol, and propylene glycol. Some embodiments of electrolyzer cells do not require a separate coolant stream since the water supplied to the anode and cathode electrodes provides a sufficient amount of heat dissipation from the electrolyzer cell(s).

The flow field plates 120, 130 shown in FIG. 2 are rectangular. In other embodiments of the invention, flow field plates can be any shape suitable for a particular design of an electrochemical cell stack. As another example, the flow field plates described below with reference to FIGS. 3A-3H and FIG. 4 are circular. These flow field plates are not suitable for use in the electrolyzer cell module 100′ illustrated in FIG. 2 only because their shape is circular and not rectangular. However, as another example, a flow field plate illustrated in FIG. 5 is rectangular and is suitable for use in the electrolyzer cell module 100′.

Referring now to FIG. 3A, illustrated is a front surface of a circular anode flow field plate 220. The front surface of the anode flow field plate 220 has a central region 201 and a peripheral region 202 surrounding the central region 201.

In this particular embodiment, the peripheral region 202 includes six manifold apertures. Three of the six manifold apertures are used for inputs. There is an anode water inlet manifold aperture 136, an anode coolant inlet manifold aperture 138, and a second anode water inlet manifold aperture 140. The other three manifold apertures are used for complementary outputs. There is an anode water/oxygen outlet manifold aperture 137, an anode coolant outlet manifold aperture 139 and an anode water/hydrogen outlet manifold aperture 141. In some embodiments, the second anode water inlet manifold aperture 140 and the water/hydrogen outlet manifold aperture 141 are both used as outputs for hydrogen produced in a respective electrolyzer cell.

In contrast to a conventional design, the anode water/oxygen manifold apertures 136, 137 have substantially the same areas as the anode water/hydrogen manifold apertures 140, 141, respectively. In some embodiments, as is shown in FIG. 3A, the anode water/oxygen manifold apertures 136, 137 have substantially the same areas as one another as well. The anode coolant manifold apertures 138, 139 are also the same size as the manifold apertures 136, 137 and 140, 141. It should be noted that the relative sizing of the manifold apertures with respect to one another is not essential and that each may be a different size depending upon the requirements of a particular application. However, in some applications, making all of the manifold apertures the same size does simplify the design of a flow field plate and possibly reduces associated manufacturing and assembly costs.

The peripheral region also includes a number of through holes 221 to accommodate tie rods (not shown) used to assemble an electrolyzer cell module.

Referring now to FIGS. 3C-3E, and with further reference to FIG. 3A, the central region 201 of the front surface of the anode flow field plate 220 includes a water flow field 132. The water flow field 132 includes a number of open-faced channels that fluidly connect the water inlet manifold aperture 136 to the water/oxygen outlet manifold aperture 137. However, in this embodiment, water cannot flow directly from the inlet manifold aperture 136 to the flow field 132 over the front surface of the anode flow field plate 220; nor can water/oxygen flow from the flow field 132 directly to the outlet manifold aperture 137 over the front surface of the anode flow field plate 220. The present embodiment of the invention, illustrated in FIGS. 3A-3H, advantageously employs “back-side feed” as described in the applicant's co-pending U.S. application Ser. No. 09/855,018, which was incorporated by the reference above. A water/oxygen flow between the flow field 132 and the manifold apertures 136, 137 will be described in more detail below.

A sealing surface 200 is provided around the flow field 132, the various manifold apertures 136-141 and the through holes 221 to accommodate a seal that is employed to prevent leaking and mixing of process gases/fluids. The sealing surface 200 is formed completely enclosing the flow field 132 and the various manifold apertures 136-141. In this particular embodiment, the sealing surface 200 is meant to completely separate the various manifold apertures 136-141 from one another and the flow field 132 on the front surface of the anode flow field plate 220. In some embodiments, the sealing surface 200 may have a varied depth (in the direction perpendicular to the plane of FIG. 3A) and/or width (in the plane of FIG. 3A) at different positions around the anode flow field plate 220. In other embodiments, the sealing surface 200 may be flush with the front surface.

In this particular embodiment, the sealing surface 200 is bounded by a raised portion 223 around the outside edge of the flow field plate 220 and raised portions 222 around the inside edges of the various manifold apertures 136-141 and through holes 221.

Also included are sets of slots 280, 280′ that are respectively provided adjacent the water inlet manifold aperture 136 and the water/oxygen outlet manifold aperture 137. The slots 280, 280′ penetrate the thickness of the anode flow field plate 220, thereby fluidly connecting the front and rear surfaces of the anode flow field plate 220. Each set of slots 280, 280′ is shown as a collection of multiple apertures. However, in other embodiments each set of slots 280, 280′ can be provided as a single aperture. With reference to the applicant's co-pending U.S. application Ser. No. 09/855,018, the sets of slots 280, 280′ are otherwise known as “back-side feed” apertures.

With specific reference to FIGS. 3A and 3C, illustrated is one example pattern that can be employed for the water flow field 132 on the front surface of the anode flow field plate 220 according to aspects of an embodiment of the invention. The water flow field 132 includes a number of water flow channels 171 that are in fluid communication with the slots 280, 280′. The water flow channels 171 are defined by a respective number of ribs 172. In this particular embodiment, two water flow channels 171, defined by three ribs 172, fluidly connect two corresponding slots 280, 280′.

Each water flow channel 171 has a first straight portion 171a, a tortuous portion 171b, an arc portion 171c and a second straight portion 171d. The first and second straight portions 171a, 171d are in fluid communication with respective slots 280, 280′. In order to offset and accommodate all of the water flow channels 171, each of the portions 171a, 171b, 171c and 171d of any one of the water flow channels 171 extends to a different extent as respectively compared to those of a neighboring one of the water flow channels 171. For example, some of the water flow channels 171 have longer straight portions 171a, 171d and a shorter tortuous portion 171b and a shorter arc portion 171c, while others have shorter straight portions 171a, 171d and a longer tortuous portion 171b and a longer arc portion 171c. However, in order to achieve a substantially uniform heat distribution and, possibly, in turn a substantially uniform reaction rate over the flow field 132, water within each of the flow channels 171 is preferably subjected to substantially the same heat exchange history as water in any of the other flow channels 171. In some embodiments of the invention, this is accomplished by making all of the flow channels 171 substantially the same total length.

The rear surface of the anode flow field plate 220 is illustrated in FIG. 3B. In this particular embodiment, the rear surface of the anode flow field plate 220 includes an optional coolant flow field 144 having a number of open-faced flow channels. The coolant flow field 144 fluidly connects the anode coolant inlet manifold aperture 138 to the anode coolant outlet manifold aperture 139. The rear surface also includes a sealing surface 400 that separates the manifold apertures 136, 137, 140 and 141 from the coolant flow field 144 and the manifold apertures 138, 139. In some embodiments, within an assembled electrochemical cell, a seal is seated on the sealing surface 400 to prevent leaking or mixing of process gases/fluids.

The sealing surface 400 is defined by a raised portion 224 around each of the manifold apertures 136, 137, 140 and 141, and collectively around the coolant flow field 144 and the manifold apertures 138, 139. The sealing surface 400 may have varied depth and/or width at different positions around the anode flow field plate 220, as may be desired. However, whereas the sealing surface 200 on the front surface completely separates all of the various manifold apertures 136-141 from the water flow field 132, the sealing surface 400 only completely separates the manifold apertures 136, 137, 140 and 141 from the coolant flow field 144, permitting coolant to flow to and from the coolant flow field 144 via the manifold apertures 138, 139.

In other embodiments, for example air-cooled (i.e. air-breathing) electrochemical stacks, ambient air is used as a coolant. In such cases and in other embodiments, the coolant flow field 144 can be omitted.

Referring now to FIGS. 3B-3H, on the rear surface of the anode flow field plate 220, the manifold apertures 136, 137 each have a respective set of aperture extensions 281, 281′. Each set of aperture extensions 281, 281′ is provided with a respective set of protrusions 282, 282′ that extend between the corresponding slots 280, 280′. Each set of protrusions 282, 282′ defines a respective set of flow channels 284, 284′. The sets of flow channels 284, 284′ stop short of the corresponding edges of the manifold apertures 136, 137, respectively, thereby facilitating the water flow between the slots 280, 280′ and the corresponding manifold apertures 136, 137. The sealing surface 400 collectively separates the aperture extensions 281, 281′ and the slots 280, 280′ from the coolant flow field 144 and other manifold apertures 138-141.

The manifold apertures 140, 141 also have respective sets of aperture extensions 181, 181′. Each set of aperture extensions 181, 181′ is provided with a respective set of protrusions 182, 182′ that extend towards the corresponding manifold apertures 140, 141. Each set of protrusions 182, 182′ is manufactured such that they extend between corresponding slots 180, 180′ on a complementary configured cathode flow field plate 230 (shown in FIG. 4).

On the rear surface of the anode flow field plate 220 the sets of protrusions 182, 182′ define corresponding sets of flow channels 184, 184′ that stop short of the corresponding edges of the manifold apertures 140, 141, respectively, thereby facilitating the water/hydrogen flow between the respective slots 180, 180′ and the corresponding manifold apertures 140, 141. The sealing surface 400 collectively separates the aperture extensions 181, 181′ (and, eventually the respective slots 180, 180′) from the coolant flow field 144 and the other manifold apertures 136-139.

With specific reference to FIGS. 3B, 3F and 3G, illustrated is one example pattern that can be employed for the flow channels of the coolant flow field 144 on the rear surface of the anode flow field plate 220 according to aspects of an embodiment of the invention. Specifically, the coolant flow field 144 includes a number of coolant flow channels 191 that fluidly connect the coolant inlet manifold aperture 138 to the coolant outlet manifold aperture 139. The coolant flow channels 191 are defined by a respective number of ribs 192. In this particular embodiment, each of the coolant flow channels 191 are defined by two ribs 192. Each coolant flow channel 191 has a first straight portion 191a, a tortuous portion 191b, an arc portion 191c and a second straight portion 191d. The first and second straight portions 191a and 191d are in fluid communication with the coolant inlet aperture 138 and the coolant outlet aperture 139, respectively.

In order to offset and accommodate all of the coolant flow channels 191, each of the portions 191a, 191b, 191c and 191d of anyone of the coolant flow channels 191 extends to a different extent as respectively compared to those of a neighboring one of the coolant flow channels 191. For example, some of the coolant flow channels 191 have longer straight portions 191a and/or 191d and a shorter tortuous portion 191b and a shorter arc portion 191c while others have shorter straight portions 191a, 191d and a longer tortuous portion 191b and a longer arc portion 191c. However, in order to achieve a substantially uniform heat distribution over the flow field 144, coolant in each of the flow channels 191 is preferably subjected to substantially the same heat exchange history as coolant in any of the other flow channels 191. In some embodiments of the invention, this is accomplished by making all of the flow channels 191 substantially the same total length.

In operation, water flows out from the water inlet manifold aperture 136 and through the flow channels 284 in the aperture extensions 281 on the rear surface of the anode flow field plate 220. At the end of the flow channels 284, water then flows through the slots 280 leaving the rear surface and entering the flow channels 171 on the front surface of the anode flow field plate 220. Specifically, water flows from the slots 280 into the first straight portions 171a of the flow channels 171. The water then flows through the tortuous portions 171b and arc portions 171c, and subsequently through the second straight portions 171d into the slots 280′. A combination of water and oxygen leaves the front surface of the anode flow field plate 220 via the slots 280′ and enters the flow channels 284′ of the aperture extensions 281′ on the rear surface. The combination of water and oxygen flows out of the flow channels 284′ and into the water/oxygen manifold aperture 137.

As the water flows along the flow channels 171, at least a portion of the water diffuses across a GDM and reacts at an anode catalyst layer of a MEA. Those skilled in the art will appreciate that the water that reacts at the anode catalyst layer does so by dissociating into hydrogen ions, free electrons, and oxygen molecules according to reaction (1) described above. The oxygen remains dissolved in the un-reacted water (since the water flow is usually pressurized) and is carried out of the flow channels 171. The hydrogen ions migrate across an electrolyte layer to a respective cathode flow field plate (e.g. as shown in FIG. 4), where they are reduced to hydrogen molecules according to reaction (2) described above.

Simultaneously, on the rear surface of the anode flow field plate (shown in FIG. 3B), coolant enters the anode coolant inlet manifold aperture 138, flows through the flow channels 191 and ultimately exits the coolant flow field 144 via the anode coolant outlet manifold aperture 139. Specifically, the coolant flows from the coolant inlet manifold aperture 138 into the first straight portions 191a of the coolant flow channels 191. The coolant then flows through the tortuous portions 191b and the arc portions 191c, and subsequently through the second straight portions 191d into the coolant outlet manifold aperture 139.

Referring now to FIG. 4, illustrated is a front surface of a cathode flow field plate 230 that includes a similar arrangement of features to those of the anode flow field plate 220. In this particular embodiment, the front surface of the cathode flow field plate 230 has substantially the same arrangement as the anode flow field plate 220. The combination of the two plates will be discussed further below.

The cathode flow field plate 230 is circular and has a central region 301 and a peripheral region 302 surrounding the central region 301. In this particular embodiment, the peripheral region 302 includes six manifold apertures. Three of the six manifold apertures are used for inputs. There is a cathode water inlet manifold aperture 156, a cathode coolant inlet manifold aperture 158, and a second cathode water inlet manifold aperture 160. The other three manifold apertures are used for complementary outputs. There is a cathode water/oxygen outlet manifold aperture 157, a cathode coolant outlet manifold aperture 159 and a cathode water/hydrogen outlet manifold aperture 161. In some embodiments, the cathode water inlet manifold aperture 160 and the water/hydrogen outlet manifold aperture 161 are both used as outputs for hydrogen produced in a respective electrolyzer cell.

A number of through holes 231 are also provided in the peripheral region 302 through which tie rods (not shown) can pass through to secure an electrolyzer cell stack together.

The front surface of the cathode flow field plate 230 is provided with a hydrogen flow field 142 comprising a plurality of open-faced channels. The flow field 142 fluidly connects the manifold apertures 156, 157 to one another. However, the combination of hydrogen and water does not flow directly from the flow field 142 to or from the manifold apertures 160, 161 directly over the front surface of the cathode flow field plate 230. The hydrogen flow between the flow field 142 and the manifold apertures 160, 161, respectively, will be described in more detail below.

On the cathode flow field plate 230 sets of slots 180, 180′ are provided adjacent the second water inlet manifold aperture 160 and the water/hydrogen outlet manifold aperture 161, respectively. The sets of slots 180, 180′ penetrate the thickness of the cathode flow field plate 230, thereby providing fluid communication between the front and rear surfaces of the cathode flow field plate 230. Specifically, the sets of slots 180, 180′ are in direct fluid communication with the flow field 142 on the front surface of the cathode flow field plate 230, and in direct fluid communication with manifold apertures 160, 161 on the rear surface of the cathode flow field plate 230.

Each set of slots 180, 180′ is shown as a collection of multiple apertures. However, in other embodiments each set of slots 180, 180′ can be provided as a single aperture. With reference to the applicant's co-pending U.S. application Ser. No. 09/855,018, the sets of slots 180, 180′ are otherwise known as “back-side feed” apertures.

A sealing surface 300 is provided around the flow field 142 and the various manifold apertures 156-161. The sealing surface 300 accommodates a seal to prevent leaking or mixing process gases/fluids. The sealing surface 300 is arranged to completely separate the various manifold apertures 156-161 from one another and the flow field 142. The sealing surface 300 may have varied depth (in the direction perpendicular to the plane of FIG. 4) and/or width (in the plane of FIG. 4) at different positions around the cathode flow field plate 230.

In this particular embodiment, the rear surface of the cathode flow field plate 230 is substantially flat and will not be described in detail herein. Those skilled in the art will appreciate that the through holes 221, the slots 180, 180′ and the various manifold apertures 156-161 penetrate the thickness of the cathode flow field plate 230. Accordingly, only these features will be noticeable on the rear surface of the cathode flow field plate 230, unless it is very thin.

In operation, water flows through the slots 180 leaving the rear surface and enters the flow channels of the flow field 142 on the front surface of the cathode flow field plate 230. As the water flows along the flow channels of the flow field 142, it hydrates the cathode side of an electrolyte (e.g. an electrolyte membrane). Those skilled in the art will appreciate that, during operation, the hydrogen ions migrate across an electrolyte layer to the cathode flow field plate 230, where they are reduced to hydrogen molecules according to reaction (2) described above. A combination of water and hydrogen leaves the front surface of the cathode flow field plate 230 via the slots 180′.

In some embodiments, when an electrochemical cell stack is assembled, the rear surface of an anode flow field plate of one electrochemical cell abuts against that of a cathode flow field plate of an adjacent electrochemical cell. The various manifold apertures are arranged to align with one another to form ducts or elongate channels extending through the electrochemical cell stack that, at their ends, are fluidly connectable to respective ports included on one or more of the end-plates.

With specific reference to FIGS. 3B and 4, the anode and cathode flow field plates 220, 230 have rear surfaces designed to abut one another. Moreover, on the anode flow field plate 220 and the cathode flow field plate 230 the various manifold apertures 136-141 and 156-161, respectively, align with one another to form six ducts or elongate channels extending through the electrochemical cell stack.

In some embodiments, a seal is arranged between the sealing surface 400 on the rear surface of the anode flow field plate 220 and the smooth rear surface of the cathode flow field plate 230 to achieve sealing between the two plates. Subsequently, the manifold apertures 160, 161 of the cathode flow field plate 230 and the respective sets of aperture extensions 181, 181′ of the anode flow field plate 220 respectively define two corresponding chambers with distinct portions of the rear surface of the cathode flow field plate 230.

In a similar arrangement, the manifold apertures 136, 137 and the respective aperture extensions 281, 281′ of the anode flow field plate 220 respectively define two other chambers with the other distinct portions of the rear surface of the cathode flow field plate 230.

With reference to FIGS. 3A-3H and 4A, in operation water flows through the duct formed by the anode and cathode manifold apertures 136 and 156, and flows to the aforementioned chambers defined by the rear surfaces of the anode and cathode flow field plates 220, 230. For each electrolyzer cell, the water flows onto the front surface of the anode flow field plates 220, as described above. Once a combination of water and oxygen exits an electrolyzer cell it flows through the duct formed by the anode and cathode manifold apertures 137 and 157, and leaves the electrolyzer cell stack.

Similarly, water also flows through the duct formed by the anode and cathode manifold apertures 140 and 160 to the other aforementioned chambers defined by the rear surfaces of the anode and cathode flow field plates 220, 230. Then for each electrolyzer cell the water flows onto the front surface of the respective cathode flow field plate 230, as described above. Once a combination of water and hydrogen exits an electrolyzer cell it flows through the duct formed by the anode and cathode manifold apertures 141 and 161 and leaves the electrolyzer cell stack.

In one alternative embodiment, for example, the sets of aperture extensions 181, 181′ and the respective sets of protrusions 182, 182′ are arranged on the rear surface of the cathode flow field plate 230, instead of on the rear surface of the anode flow field plate 220. In such embodiments, a sealing surface is provided on the rear surface of the cathode flow field plate 230 and is configured such that it collectively encloses the manifold apertures 160, 161 and the associated sets of aperture extensions 181, 181′, the respective set of protrusions 182, 182′ as well as the corresponding slots 180, 180′.

As another alternative, the sets of aperture extensions for a particular process gas/fluid are provided on the rear surface of a flow field plate that produces the particular process gas/fluid, during operation, on its front surface. Accordingly, sets of slots can be provided in each plate that fluidly connect the front surface of the flow field plate to the rear surface of the flow field plate.

In another alternative embodiment, each of the anode and cathode flow field plates is provided with sets of aperture extensions for both the water/oxygen flow and the water/hydrogen flow. In effect, an extension chamber would then be provided, partly in one of the plates and partly in the other of the plates, extending from the respective manifold aperture(s), towards slots extending through to the front surface of a flow field plate. This configuration may be desirable where the thickness of each of the flow field plates is reduced.

In other embodiments, the anode and cathode flow field plates are identical. In such embodiments, it may be desirable to provide coolant channels on each of the anode and cathode flow field plates half the depth of the coolant channels in the case where only the rear surface of the anode flow field plate is provided with a coolant flow field. This would maintain the same amount of space for coolant flow, yet make it possible to make each flow field plate thinner. Moreover, if the anode and the cathode flow field plates are identical, as may be the case in some embodiments, a single flow field plate design can be used to make up all the cells of a stack. This simplification may in turn lead to a simplification in production steps, which may lead to lower manufacturing costs and shorter assembly times.

In related embodiments, in order to ensure that the manifold apertures on flow field plates align when an electrochemical cell stack is assembled, the manifold apertures will not only have the same dimensions, but they are also symmetrically arranged with respect to a virtual axis of the flow field plate. Understandably, the coolant apertures also have to align when the stack is assembled. This also means that the coolant apertures are also symmetrically arranged with respect to the same virtual axis.

An example of an alternative flow field plate is illustrated in FIG. 5 that includes aspects of an embodiment of the invention. Specifically, FIG. 5 shows the front surface of a rectangular flow field plate 120 that can be used for either an anode flow field plate or a cathode flow field plate within an electrochemical cell, such as, for example, the electrolyzer cell module 100′ illustrated in FIG. 2.

The flow field plate 120 includes a first inlet manifold aperture 336, a coolant inlet manifold aperture 338 and a second inlet manifold aperture 340 on one end. On the opposite end, the flow field plate 120 includes a first outlet manifold aperture 337, a coolant outlet manifold aperture 339, and a second outlet manifold aperture 341. Although all of the inlets and outlets are arranged at opposite ends of the flow field plate 120, those skilled in the art would appreciate that various other arrangements are possible.

In contrast to conventional design, the manifold apertures 336, 337 have substantially the same area as the manifold apertures 340, 341, respectively. In some embodiments, the manifold apertures 336, 337 have substantially the same area as one another as well. The coolant manifold apertures 338, 339 are shown to be smaller than the other manifold apertures 336, 337, 340 and 341. However, this is not essential and all of the manifold apertures 336-341 may be the same size in some embodiments, or alternatively some may be different sizes depending upon the requirements of a particular application.

The flow field plate 120 is provided with a flow field 332 that includes a number of open-faced channels. The flow field 332 fluidly connects the manifold apertures 340, 341. The flow field 332 is described in greater detail below.

Similar to the design of the anode and cathode flow field plates 220, 230 described above, the flow field plate 120 also includes “back side feed” apertures (i.e. slots) 380, 380‘as disclosed in the applicant’s co-pending U.S. application Ser. No. 09/855,018, that was incorporated by reference above. The slots 380, 380′ are respectively provided adjacent the manifold apertures 340, 341. The slots 380, 380′ penetrate the thickness of the flow field plate 120, thereby fluidly connecting the front and rear surfaces of the flow field plate 120. Each of the slots 380, 380′ is shown as a singular aperture in FIG. 5. However, in other embodiments each of slots 380, 380′ can be provided as a set of multiple apertures.

The flow field plate 120 is also provided with a sealing surface 500 that is arranged around the flow field 132 and the various manifold apertures 336-341 to accommodate a seal for the prevention of leakage and mixing of process gases/fluids. The sealing surface 500 may have varied depth and/or width at different positions around the flow field plate 120.

One example of a pattern that can be employed for the flow field 332 is illustrated in FIG. 5. The flow field 332 includes a number of inlet distribution flow channels 370 that are in fluid communication with the slot 380. In order to offset and accommodate all of the inlet distribution flow channels 370, each of the inlet distribution flow channels 370 have different longitudinal and transversal extents. Specifically, some of the inlet distribution flow channels 370 have a shorter longitudinally extending portion 370a immediately adjacent the slot 380 and a longer transversely extending portion 370b. Each of the inlet distribution flow channels 370 divides into a number of primary flow channels 372 that are defined by a corresponding number of ribs 373. The primary flow channels 372 are straight and extend in parallel along the length of the flow field 372.

Moreover, in order to achieve a substantially uniform heat distribution and, possibly, in turn a substantially uniform reaction rate over the flow field 332, a process gas/fluid within each of the primary flow channels 372 is preferably subjected to substantially the same heat exchange history as the process gas/fluid in any of the other primary flow channels 373. In some embodiments of the invention, this is accomplished by making all of the flow channels 372 substantially the same length. As shown for example, given any two primary flow channels 372 having lengths L₁ and L₂, the lengths L₁ and L₂ are approximately equal to one another.

At the outlet end of the flow field plate 120, the flow field 332 includes a number of outlet collection flow channels 371 that are provided in fluid communication with the slot 380′. In order to offset and accommodate all of the outlet collection flow channels 371, each of the outlet collection flow channels has different longitudinal and transversal extents. Specifically, some of the outlet collection flow channels 371 have a shorter longitudinally extending portion 371a immediately adjacent the slot 380′ and then a longer transversely extending portion 371b. The outlet collection flow channels 371 are positioned in complementary correspondence with the inlet distribution flow channels 370. Accordingly, the primary flow channels 332 divided from each of the inlet distribution flow channels 370 then converge into the outlet collection flow channels 371.

It is to be noted that the longitudinally extending portions of the inlet distribution and outlet collection flow channels 370, 371 are significantly shorter, as compared to the length of the primary flow channels 372. The number of primary flow channels 372 that is associated with each inlet distribution and outlet collection flow channel 370, 371 may or may not be the same. The width of the ribs 373 and/or flow channels 372 can be adjusted to obtain different channel to rib ratios. It is not essential that all the primary flow channels 372 divided from one of the inlet distribution channels 370 are connected to a particular one of the outlet collection channels 371, and vice versa. For some embodiments, effort is made to make the primary flow channels almost identical in length so that process gas/fluids traversing a flow field plate experience the same heat exchange history across the surface of the plate. This may, in turn, provide relatively uniform heat distribution over the area of a flow field plate.

In the foregoing, flow channels for fuel gas, oxidant and coolant have been designated as “primary”, in the sense that such channels will generally be central in a flow field plate and will generally make up the majority of the flow channels provided. The primary flow channels are selected to provide uniform fuel distribution across a surface.

The inlet distribution and outlet collection flow channel configurations included on a flow field plate provides a branching structure where gas flow first passes along one channel (the inlet distribution flow channel) and then branches into a number of smaller channels (the primary flow channels). This structure could include further levels of subdivision. For example, the inlet distribution flow channels could be connected to a number of secondary distribution flow channels that are arranged between the inlet distribution flow channels and the primary flow channels. Similarly, there may be a secondary set of collection flow channels arranged between the primary flow channels and the outlet collection flow channels.

The use of the flow field plate 120 is similar to the use of the anode and cathode flow field plates 220, 230 described above. Thus, for the sake of brevity, the use of the flow field plate will not be described, as those skilled in the art will be able to appreciate various possibilities for its use after reviewing the foregoing descriptions.

While the above description provides examples according to aspects of embodiments of the invention, it will be appreciated that the present invention is susceptible to modification and change without departing from the fair meaning and scope of the accompanying claims. Accordingly, what has been described is merely illustrative of the application of some aspects of embodiments of the invention. It is therefore to be understood that within the scope of the appended claims, the invention may be practiced otherwise than as specifically described herein.

1. A flow field plate suited for use in an electrochemical cell comprising:
a front surface and a rear surface;
a plurality of manifold apertures;
a flow field, on the front surface, fluidly connecting two of the manifold apertures, having a plurality of open-faced flow channels that are all substantially the same length and arranged to uniformly distribute both a first process gas/fluid and heat produced by an electrochemical reaction involving the first process gas/fluid over an area covered by the flow field on the front surface of the flow field plate.

2. A flow field plate according to claim 1 that is circular in shape and has a central region and a peripheral region surrounding the central region on the front surface, wherein the flow field is arranged within the central region and the plurality of manifold apertures are symmetrically arranged in the peripheral region.

3. A flow field according to claim 2, wherein each of the open-faced channels include, in sequence, a first straight portion in fluid communication with a first one of the manifold apertures, a tortuous portion, an arc portion, and a second straight portion in fluid communication with a second one of the manifold apertures.

4. A flow field plate according to claim 1 that is rectangular in shape and the open-faced channels are comprised of a plurality of substantially straight and parallel primary flow channels that extend along the length of the flow field plate.

5. A flow field plate according to claim 4 further comprising:
a plurality of inlet distribution flow channels that are fluidly connected between a first one of the manifold apertures and the primary flow channels, and wherein each of the inlet distribution flow channels has a longitudinally extending portion and a transversely extending portion; and
a plurality of outlet collection flow channels that are fluidly connected between a second one of the manifold apertures and the primary flow channels, and wherein each of the outlet collection flow channels has a longitudinally extending portion and a transversely extending portion.

6. A flow field plate according to claim 1 further comprising:
a coolant flow field, on the rear surface, fluidly connecting two of the manifold apertures, having a plurality of open-faced flow channels that are all substantially the same length and arranged to uniformly distribute coolant on the rear surface of the flow field plate.

7. A flow field plate according to claim 6 that is circular in shape and has a central region and a peripheral region surrounding the central region on the rear surface, wherein the coolant flow field is arranged within the central region and the plurality of manifold apertures are symmetrically arranged in the peripheral region.

8. A flow field according to claim 7, wherein each of the open-faced channels include, in sequence, a first straight portion in fluid communication with a first one of the manifold apertures, a tortuous portion, an arc portion, and a second straight portion in fluid communication with a second one of the manifold apertures.

9. A flow field plate according to claim 6 that is rectangular in shape and the open-faced channels of the coolant flow field are comprised of a plurality of substantially straight and parallel primary coolant flow channels that extend along the length of the flow field plate.

10. A flow field plate according to claim 9 further comprising:
a plurality of coolant inlet distribution flow channels that are fluidly connected between a first one of the manifold apertures and the primary coolant flow channels, and wherein each of the coolant inlet distribution flow channels has a longitudinally extending portion and a transversely extending portion; and
a plurality of coolant outlet collection flow channels that are fluidly connected between a second one of the manifold apertures and the primary coolant flow channels, and wherein each of the outlet coolant collection flow channels has a longitudinally extending portion and a transversely extending portion.

11. A flow field plate according to claim 1 further comprising:
a first slot, extending through the flow field plate, that is in fluid communication with the open-faced channels of the flow field on the front surface and in fluid communication with a first one of the manifold apertures on the rear surface; and
a second slot, extending through the flow field plate, that is in fluid communication with the open-faced channels of the flow field on the front surface and in fluid communication with a second one of the manifold apertures on the rear surface.

12. A flow field plate according to claim 11 further comprising:
a first set of aperture extensions extending from the first one of the manifold apertures to the first slot, over a portion of the rear surface; and
a second set of aperture extensions extending from the second one of the manifold apertures to the second slot, over a portion of the rear surface.

13. A flow field plate according to claim 1 further comprising a sealing surface on the front surface of the flow field plate completely separating each of the manifold apertures from one another and the flow field on the front surface of the flow field plate.

14. A flow field plate according to claim 1 further comprising:
a coolant flow field fluidly, on the rear surface, connected between two of the manifold apertures;
a sealing surface, on the rear surface, collectively separating the two manifold apertures and the coolant flow field from the other manifold apertures.

15. A flow field plate according to claim 1, wherein some of the manifold apertures are used to supply or evacuate process gases/fluids and each of these manifold apertures has substantially the same area as the other manifold apertures also used to supply or evacuate process gases/fluids.

16. A flow field plate according to claim 15, wherein all of the manifold apertures used to supply or evacuate respective process gases/fluids also have substantially identical dimensions.

17. A flow field plate suited for use in an electrochemical cell comprising a flow field having a plurality of open-faced flow channels that are all substantially the same length and arranged to uniformly distribute both a first process gas/fluid and heat produced by an electrochemical reaction involving the first process gas/fluid over an area covered by the flow field.

18. A flow field plate according to claim 17 further comprising:
a plurality of substantially identical manifold apertures that are arranged to align with respective manifold apertures on other similar flow field plates to form a corresponding plurality of elongate channels that each extend through the thickness of a combined number of similar flow field plates.

19. An electrochemical cell stack including at least one electrochemical cell, each electrochemical cell comprising:
a plurality of flow field plates each including a flow field;
wherein, each flow field includes a plurality of open-faced flow channels that are all substantially the same length and arranged to uniformly distribute both a first process gas/fluid and heat produced by an electrochemical reaction involving the first process gas/fluid over an area covered by the flow field; and
wherein some of the flow field plates are employed as an anode and some of the flow field plates are employed as a cathode.

20. An electrochemical cell stack according to claim 19, wherein all of the plurality of flow field plates have substantially identical manifold apertures and wherein the respective manifold apertures on the flow field plates align to form a corresponding plurality of elongate channels that each extend through the electrochemical cell stack.
